(19) United States
(12) Patent Application Publication
(10) Pub. No.: US 2011/0170908 A1
(43) Pub. Date: Jul. 14, 2011

(54) Lubricant supplying device, process cartridge, and image forming apparatus

(75) Inventors: Hiroshi Saitoh, Tokyo (JP); Takaaki Tawada, Kanagawa (JP); Akira Fujimori, Kanagawa (JP)

(73) Assignee: Ricoh Company, Limited, Tokyo (JP)

(21) Appl. No.: 12/926,853

(22) Filed: Dec. 14, 2010

(30) Foreign Application Priority Data
Jan. 12, 2010 (JP) 2010-004448

(51) Int. Cl. G03G 21/00

(52) U.S. Cl. 399/127; 399/346

(57) ABSTRACT

A lubricant applying unit that applies lubricant to a photosensitive element includes solid lubricant blended with fatty acid metal salt, a lubricant supplying brush roller, a lubricant applying blade, and a biasing unit of the solid lubricant. In addition, a lubricant applying unit that applies lubricant to an intermediate transfer belt includes solid lubricant blended with inorganic lubricant, a lubricant supplying brush roller, a lubricant applying blade, and a biasing unit of the solid lubricant blended with the inorganic lubricant.

### CROSS-REFERENCE TO RELATED APPLICATIONS

The present application claims priority to and incorporates by reference the entire contents of Japanese Patent Application No. 2010-004448 filed in Japan on Jan. 12, 2010.

### BACKGROUND OF THE INVENTION

1. Field of the Invention

The present invention relates to a lubricant supplying device that applies lubricant to a surface of a photosensitive element and a surface of an intermediate transfer body to form a thin layer of the lubricant, a process cartridge including the lubricant supplying device, and an image forming apparatus including the lubricant supplying device.

2. Description of the Related Art

A structure has been known in which a lubricant supplying device applying lubricant to a surface of an image carrier to form a thin layer of the lubricant and a process cartridge including the lubricant supplying device are used for an image forming apparatus such as an electronic copying machine, a printer, a facsimile, and a multifunction peripheral (MFP) thereof.

The image carrier is a photosensitive element or an intermediate transfer body to which a toner image on the photosensitive element is transferred. Applying lubricant to a surface of such image carrier lowers a friction coefficient of the surface and can reduce a friction force acting between the image carrier surface and a member abutting the surface. This reduction of the friction force suppresses the image carrier surface from being worn. As a result, the image carrier can lengthen its life.

As disclosed in Japanese Patent Application Laid-open No. 2002-91232, a structure also has been known in which fatty acid metal salt such as zinc stearate is used as lubricant. However, it has become obvious that such lubricant changes its characteristics by being affected by discharge taken place near the image carrier and loses lubricity relatively early. For example, when the image carrier is a photosensitive element, the photosensitive element is charged with a predetermined polarity by discharge produced between a charging unit and the photosensitive element. The discharge deteriorates lubricant applied to a surface of the photosensitive element. Particularly, lubricity is significantly lowered when AC charging is used. In a system using an AC charging roller, cleaning property is markedly lowered by an increase in photosensitive element friction resistance. The lowering of the cleaning property causes a problem in that the charging roller is early contaminated due to an increase in a pass-through of toner or lubricant powder.

When the image carrier is an intermediate transfer body, a toner image on the intermediate transfer body is transferred to a transfer member by discharge taken place between the intermediate transfer body and a transfer roller provided to a transfer unit. Consequently, a problem arises in that such discharge causes lubricant applied to a surface of the intermediate transfer body to lose lubricity.

Meanwhile, Japanese Patent Application Laid-open No. 2006-350240 discloses lubricant in which boron nitride serving as inorganic lubricant is blended with fatty acid metal salt. When boron nitride is used as lubricant, the lubricant applied on an image carrier as a film is not early deteriorated by discharge produced during operation of a charging roller or a transfer roller. This is because boron nitride hardly changes its characteristics by discharge and hardly loses lubricity in comparison with other lubricants even if boron nitride is subjected to discharge. In addition, boron nitride can prevent a layer that forms a surface of the image carrier from oxidizing and vaporizing by discharge.

However, if lubricant containing boron nitride alone is used, the lubricant applied to a surface of the image carrier may not cover the entire surface of the image carrier and a lubricant film may not be uniformly formed on the entire surface of the image carrier. In this regard, Japanese Patent Application Laid-open No. 2006-350240 discloses lubricant in which fatty acid metal salt is blended in addition to boron nitride that does not lose lubricity by being subjected to discharge while other lubricant loses lubricity, as a structure with which a lubricant film can be efficiently formed on the entire surface of an image carrier and maintain high lubricity for a long period of time. This is because the use of the lubricant containing fatty acid metal salt enables the lubricant film to be formed on the entire surface of the image carrier.

The friction resistance of the photosensitive element surface is maintained low in this way. As a result, a pas-through of toner and lubricant powder from a cleaning blade is drastically reduced and the charging roller drastically lengthens its life, which is shortened by sticking of toner and lubricant powder.

However, there are some problems in manufacturing solid lubricant blended with fatty acid metal salt and boron nitride serving as inorganic lubricant.

Generally, methods of manufacturing solid lubricant include melting molding in which raw material is melt at a temperature above its melting point and thereafter solidified in a metal mold, and compression molding in which powder is solidified, for example, in a metal mold by applying high pressure.

Solid lubricant manufactured by melting molding becomes harder than solid lubricant manufactured by molding fatty acid metal salt alone. When the solid lubricant containing boron nitride with a mixing rate of about more than 5% is chipped off with a brush roller or a sponge roller, the roller needs to be pressed to the solid lubricant with high pressure. This high pressure causes a problem of durability of the brush roller or the sponge roller in practical use.

In contrast, solid lubricant manufactured by the compression molding can be chipped off with the brush roller or the sponge roller as has been conventionally done. The compression molding, however, has a problem in that a molding apparatus is larger than that of the melting molding and requires high costs. In addition, another problem arises in that what is called filming is likely to occur in which, for example, toner sticks to the photosensitive element surface as a result of mixing boron nitride into fatty acid metal salt.

In order to prevent the filming in which toner and the like stick to the photosensitive element surface, the applying amount of lubricant to the photosensitive element surface needs to be drastically increased. The volume of solid lubricant for maintaining the effect of the lubricant for a long period of time causes a problem in a lubricant applying unit that applies lubricant to the photosensitive element surface, because the lubricant applying unit has no choice but to be installed in a limited space.

It is conceivable that the above-described problems arise not only when boron nitride serving as inorganic lubricant is blended with fatty acid metal salt but also when other inorganic lubricant is blended with solid lubricant.

In the present invention having the above-described structure, part of the solid lubricant that is blended with inorganic lubricant and is supplied to an intermediate transfer body is transferred to a photosensitive element at a position the intermediate transfer body contacts the photosensitive element. A tiny amount of the inorganic lubricant contained in the solid lubricant transferred to the photosensitive element can maintain lubricity of a surface of the photosensitive element. Accordingly, friction resistance of the photosensitive element surface can be maintained low for a long period of time in the same manner as when lubricant blended with inorganic lubricant is applied to the photosensitive element even if no inorganic lubricant is blended with solid lubricant applied to the photosensitive element. Consequently, the cleaning property of the photosensitive element surface can be maintained and the lives of the photosensitive element and the charging roller can be lengthened. In addition, no inorganic lubricant or a minute amount of inorganic lubricant, if it is blended, is blended with the solid lubricant supplied to the photosensitive element, whereby the solid lubricant can be manufactured by melting molding that is an inexpensive manufacturing method. This makes it unnecessary to drastically increase the volume of the solid lubricant in order to prevent filming in which toner and the like stick to the photosensitive element surface as a result of mixing inorganic lubricant into fatty acid metal salt. Consequently, a lubricant applying unit for the photosensitive element can be provided in a compact form. On the other hand, since at least inorganic lubricant is blended into the solid lubricant applied by a lubricant applying unit for the intermediate transfer body, the lubricity of the intermediate transfer body surface can be maintained in a low friction condition for a long period of time. In addition, space necessary for increasing the volume of the solid lubricant can be provided more easily than the lubricant applying apparatus for the photosensitive element and the problem of solid lubricant volume can be solved.

### SUMMARY OF THE INVENTION

It is an object of the present invention to at least partially solve the problems in the conventional technology.

According to an aspect of the present invention a lubricant supplying device comprises: a photosensitive element lubricant applying unit that is provided to each of a plurality of photosensitive elements and applies lubricant to a surface of each of the photosensitive elements; and an intermediate transfer body lubricant applying unit that applies lubricant to a surface of an intermediate transfer body that has a belt shape and to which toner images are transferred from the photosensitive elements, and the lubricant applied by the photosensitive element lubricant applying unit is solid lubricant blended with no inorganic lubricant or with a minute amount of inorganic lubricant, and the lubricant applied by the intermediate transfer body lubricant applying unit is solid lubricant blended with at least inorganic lubricant.

According to another aspect of the present invention, a process cartridge comprises: a photosensitive element; and a unit applying lubricant to the photosensitive element, the process cartridge integrally supporting the photosensitive element and at least the unit, and being able to be attached to and detached from an apparatus main body, and the unit is the photosensitive element lubricant applying unit included in the lubricant supplying.

According to still another aspect of the present invention, an image forming apparatus comprises: a plurality of photosensitive elements; and an intermediate transfer body that has a belt shape and to which toner images are transferred from the photosensitive elements; the intermediate transfer body lubricant applying unit according to any one of claims 1 to 5, the unit serving as a unit applying lubricant to a surface of the intermediate transfer body; and the photosensitive element lubricant applying unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic structural view illustrating an image forming apparatus according to an embodiment of the present invention;

FIG. 2 is an enlarged view of a process cartridge including a lubricant supplying device according to the embodiment; and

FIG. 3 is an enlarged view of an intermediate transfer belt including the lubricant supplying device according to the embodiment.

### DETAILED DESCRIPTION OF THE PREFERRED EMBODIMENTS

An embodiment in which the present invention is applied to an image forming apparatus is described in detail with reference to accompanying drawings below.

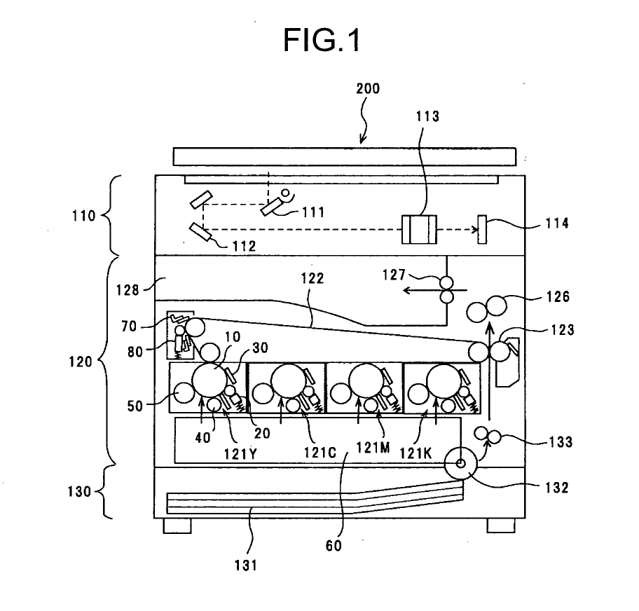

FIG. 1 is a schematic structural view illustrating an image forming apparatus including a lubricant supplying device according to the embodiment. In FIG. 1, an image forming apparatus 200 forms full color images and is mainly composed of a scanning unit 110, an image forming unit 120, and a paper feeding unit 130. In the scanning unit 110, a first scanning running body 111, a second scanning running body 112, an imaging lens 113, and a scanning sensor 114 are disposed.

The image forming unit 120 includes: four process cartridges 121 (121Y, 121C, 121M, and 121K); an endless intermediate transfer belt 122; a secondary transfer roller 123; and toner bottles (not shown) that supply toner to each of the process cartridges 121. Each of the process cartridges 121 includes: a photosensitive element 10; and a cleaning unit 30, a lubricant applying unit 20, a charging unit 40 and a developing unit 50 that are disposed around the photosensitive element 10 in the above described order.

The intermediate transfer belt 122 is disposed above and on the photosensitive element 10 of each of the process cartridges 121 and a lower side conveying surface of the intermediate transfer belt 122 abuts a circumferential surface of each photosensitive element 10. The intermediate transfer belt 122 functions as a transfer member to which toner images are transferred from the surface of each photosensitive element 10 and overlapped. Each of the toner images is formed on the surface of each photosensitive element 10 and has a different color from each other.

A primary transfer roller (not shown) is disposed at a position facing each photosensitive element 10 with the intermediate transfer belt 122 interposed therebetween.

An exposing unit 60 is disposed below an array of the process cartridges 121. The exposing unit 60 forms a static latent image by irradiating a charged image carrier surface with a laser beam based on, for example, image information.

The paper feeding unit 130 includes: a paper cassette 131 that houses transfer paper serving as a recording medium; and a feed roller 132. The feed roller 132 feeds transfer paper toward a nipping section between the intermediate transfer belt 122 and the secondary transfer roller 123 via a registration roller 133 at predetermined timing.

In addition, a fixing unit 126 is disposed at an exit side of the secondary transfer roller 123. A discharging roller 127 and a discharged paper housing unit 128 that houses discharged recording paper are provided in a downstream area of the fixing unit 126.

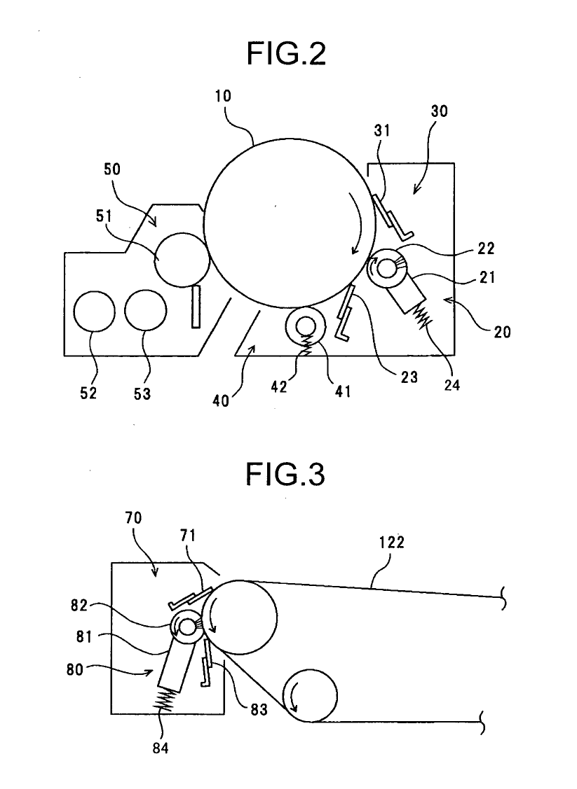

FIG. 2 is an enlarged view of the process cartridge including the lubricant supplying device of the embodiment. In FIG. 2, the process cartridge 121 mainly includes: the photosensitive element 10; and the cleaning unit 30, the lubricant applying unit 20, the charging unit 40, and the developing unit 50, which are annexed around the photosensitive element 10.

The charging unit 40 mainly includes: a charging roller 41 disposed so as to abut the photosensitive element 10; and a pressing unit 42 that makes the charging roller 41 abut the photosensitive element 10. The charging roller 41 uniformly charges the surface of the photosensitive element 10.

The developing unit 50 mainly includes: a developing roller 51; a mixing roller 52; and a supplying roller 53. The developing roller 51 supplies toner, which serves as developer, on the surface of the photosensitive element 10, and makes a static latent image visible. The mixing roller 52 agitates developer housed in a developer housing section. The supplying roller 53 supplies the developing roller 51 with developer agitated and mixed by the mixing roller 52.

The cleaning unit 30 is provided with a cleaning blade 31 that abuts the surface of the photosensitive element 10. The cleaning blade 31 collects, for example, toner remaining on the surface of the photosensitive element 10 so as to clean the surface.

The lubricant applying unit 20 mainly includes: a solid lubricant 21 formed in a bar shape; a lubricant supplying brush roller 22 that serves as lubricant supplying means and rotates by contacting with both the solid lubricant 21 and the photosensitive element 10; a lubricant applying blade 23; and a biasing unit 24. The biasing unit 24 presses the solid lubricant 21 to the lubricant supplying brush roller 22. The lubricant supplying brush roller 22 chips off the solid lubricant 21 to make powder lubricant, and applies the powder lubricant on the surface of the photosensitive element 10. The lubricant applying blade 23 levels off the lubricant applied to the surface of the photosensitive element 10 to equalize the thickness of the lubricant.

The solid lubricant used herein is blended with fatty acid metal salt and can be manufactured by melting molding that is an inexpensive manufacturing method. Examples of fatty acid metal salt include barium stearate, lead stearate, iron stearate, nickel stearate, cobalt stearate, copper stearate, strontium stearate, calcium stearate, cadmium stearate, magnesium stearate, zinc stearate, zinc oleate, magnesium oleate, iron oleate, cobalt oleate, copper oleate, lead oleate, manganese oleate, zinc palmitate, cobalt palmitate, lead palmitate, magnesium palmitate, aluminum palmitate, calcium palmitate, lead caprylate, lead caprate, zinc linolenate, cobalt linolenate, calcium linolenate, zinc ricinoleate, cadmium ricinoleate, and compounds thereof. However, the examples of fatty acid metal salt are not limited to these. Mixtures thereof also may be used. In the present invention, zinc stearate is particularly preferably used among the examples of fatty acid metal salt. This is because zinc stearate has excellent film forming property to the photosensitive element, a high ability of protecting the surface of the photosensitive element, and low moisture absorbency and further has a characteristic that lubricity is hardly deteriorated even if temperature changes.

FIG. 3 is an enlarged view of the intermediate transfer belt. In FIG. 3, a cleaning unit 70 and a lubricant applying unit 80 are provided on the surface of the intermediate transfer belt 122.

The cleaning unit 70 is provided with a cleaning blade 71 that abuts the surface of the intermediate transfer belt 122. The cleaning blade 71 collects, for example, toner remaining on the surface of the intermediate transfer belt 122 so as to clean the surface of the intermediate transfer belt 122.

The lubricant applying unit 80 mainly includes: solid lubricant 81; a lubricant supplying brush roller 82 that serves as lubricant supplying means and rotates by contacting with both the solid lubricant 81 and the intermediate transfer belt 122; a lubricant applying blade 83; and a biasing unit 84. The solid lubricant 81 is pressed toward the lubricant supplying brush roller 82 by the biasing unit 84.

The lubricant supplying brush roller 82 chips off the solid lubricant 81 to make powder lubricant and applies the powder lubricant on the surface of the intermediate transfer belt 122. The lubricant applying blade 83 levels off the lubricant applied to the surface of the intermediate transfer belt 122 to equalize the thickness of the lubricant.

The solid lubricant used herein is blended with fatty acid metal salt and inorganic lubricant, and is manufactured by compression molding in which powder lubricant is put in a metal mold and thereafter pressurized in the mold. Examples of fatty acid metal salt are the same as described above and zinc stearate is preferably used.

Here, a substance referred to as the inorganic lubricant means an inorganic compound that is cleaved (split off from a face having a weak atomic bonding force in its crystal structure) and self-lubricates or in which an internal slide occurs. Examples of the inorganic compound includes talc, mica, boron nitride, molybdenum disulphide, tungsten disulphide, kaoline, smectite, hydrotalcite compound, calcium fluoride, graphite, platy alumina, sericite, and synthetic mica. However, the examples are not limited to these. Among the compounds, boron nitride that is easily cleaved and lubricates is most preferably used because boron nitride has a structure that hexagonal network faces each composed of tightly combined atoms are layered with a large clearance interposed therebetween and only a weak Van der Waals' force acts between the layers. In addition, boron nitride has a feature that its characteristics are hardly changed by discharge and lubricity is not lost even if it is subjected to discharge while other lubricant loses lubricity. A tiny supplying amount of boron nitride can maintain lubricity.

In the present invention, since lubricant containing boron nitride is supplied to the intermediate transfer belt 122, boron nitride is supplied to the photosensitive element 10 of each color via the intermediate transfer belt 122. The supplying amount of boron nitride to the photosensitive element 10 of each color needs to be able to maintain the lubricity of the photosensitive element 10 located at a most downstream position.

While the lubricant applying blade 83 in FIG. 3 is illustrated in a counter abutment manner, the lubricant applying blade 83 may be disposed in a trailing abutment manner in order to adjust the supplying amount of boron nitride supplied to the photosensitive element 10 of each color or the lubricant applying blade 83 may be eliminated. The content of boron nitride in lubricant may be arbitrarily set so as to regulate the supplying amount of boron nitride. The content ratio is preferably from 10% to 80% in volume. If the content of boron nitride is less than the above-described range, a lubricity improvement effect of boron nitride is not expected very much and an effect for preventing lubricant from being deteriorated by discharge also may not be enhanced. In addition, it is not preferable that the content of boron nitride is more than the above-described range, because a lubricant film is not efficiently formed on the intermediate transfer belt 122.

While the brush roller is used as the lubricant supplying member in the above-described embodiment, the lubricant supplying member is not limited to the brush roller, and a sponge roller may be used, for example.

As described above, the lubricant supplying device of the present embodiment includes the lubricant applying unit 20 and the lubricant applying unit 80. The lubricant applying unit 20 applies the solid lubricant 21 to the photosensitive element 10 serving as an image carrier. The solid lubricant 21 contains a minute amount of inorganic lubricant, if the inorganic lubricant is blended. The lubricant applying unit 80 applies the solid lubricant 81 to the intermediate transfer belt 122 which serves as an image carrier. The solid lubricant 81 is blended with at least inorganic lubricant. Accordingly, the present embodiment can provide a lubricant supplying device that is inexpensive and compact, and that can maintain the cleaning property of the surface of the photosensitive element 10 and that can maintain performance of the photosensitive element 10 and the charging roller 41 in good conditions for a long period of time.

In addition, in the lubricant supplying device of the embodiment, fatty acid metal salt alone is blended with the solid lubricant 21 that is lubricant applied to the photosensitive element 10 which serves as an image carrier. The solid lubricant 21 blended with fatty acid metal salt alone is required only a small applying amount. The solid lubricant 21 blended with fatty acid metal salt alone can be manufactured by melting molding that is an inexpensive manufacturing method. This makes it possible to reduce manufacturing costs of the solid lubricant 21 applied to the photosensitive element 10. Further, it becomes unnecessary to excessively increase the volume of the solid lubricant 21 in the lubricant applying unit 20 that applies lubricant to the surface of the photosensitive element 10 and has no choice but has to be installed in a limited space.

On the other hand, in the lubricant supplying device of the embodiment, at least fatty acid metal salt and inorganic lubricant are blended with the solid lubricant 81 that is lubricant applied to the intermediate transfer belt 122 which serves as an image carrier. The solid lubricant 81 blended with fatty acid metal salt in addition to inorganic lubricant can efficiently form a lubricant film entirely on the intermediate transfer belt. Since the solid lubricant is applied to the intermediate transfer belt, space necessary for increasing the volume of the solid lubricant is provided more easily than the lubricant applying unit for the photosensitive element. Consequently, the solid lubricant 81 may be manufactured by compression molding method, and may be chipped off by, for example, a brush roller or a sponge roller as is conventionally done, without limitation due to the volume of the solid lubricant.

In the lubricant supplying device of the embodiment, zinc stearate is used as fatty acid metal salt blended with the solid lubricant 21 and 81. Zinc stearate has excellent film forming property, a high ability of protecting the surface of the image carrier, and low moisture absorbency, and further has a characteristic that lubricity is hardly deteriorated even if temperature changes. Consequently, protective lubricant film layer can be formed that is hardly affected by environmental change and has a high ability of protecting a surface of an image carrier.

In the lubricant supplying device of the present embodiment, boron nitride is used as inorganic lubricant blended with the solid lubricant 81. Boron nitride has feature that it hardly changes its characteristics by discharge and does not lose lubricity even if it is subjected to discharge in comparison to other lubricants. Because of this feature, lubricant applied on the image carrier as a film is not early deteriorated by discharge produced during operation of a charging roller or a transfer roller. Consequently, good lubricity can be maintained for a long period of time. In addition, boron nitride can prevent a surface forming layer of the image carrier from oxidizing and vaporizing by discharge.

In the image forming apparatus including the lubricant applying unit 80 for the intermediate transfer belt 122, the process cartridge 121 of the embodiment includes the lubricant applying unit 20 for the photosensitive element. This structure can demonstrate the same operations as when the above-described lubricant supplying device is provided. Consequently, a compact process cartridge may be provided that can form good images for a long period of time.

The image forming apparatus 200 of the present embodiment includes the lubricant applying unit 80 for the intermediate transfer belt 122, and the lubricant applying unit 20 for the photosensitive element 10 or the process cartridge 121. This structure can demonstrate the same operations as when the above-described lubricant supplying device or the process cartridge 121 is provided. Consequently, an image forming apparatus that can form good images for a long period of time may be provided.

The present invention can provide a lubricant supplying device that is inexpensive and compact, and can maintain cleaning property of a surface of a photosensitive element, and can maintain performance of the photosensitive element and a charging roller in good conditions for a long period of time.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A lubricant supplying device, comprising:
a photosensitive element lubricant applying unit that is provided to each of a plurality of photosensitive elements and applies lubricant to a surface of each of the photosensitive elements; and
an intermediate transfer body lubricant applying unit that applies lubricant to a surface of an intermediate transfer body that has a belt shape and to which toner images are transferred from the photosensitive elements, wherein
the lubricant applied by the photosensitive element lubricant applying unit is solid lubricant blended with no inorganic lubricant or with a minute amount of inorganic lubricant, and
the lubricant applied by the intermediate transfer body lubricant applying unit is solid lubricant blended with at least inorganic lubricant.

2. The lubricant supplying device according to claim 1, wherein the lubricant applied by the photosensitive element lubricant applying unit is solid lubricant blended with fatty acid metal salt alone.

3. The lubricant supplying device according to claim 1, wherein the lubricant applied by the intermediate transfer body lubricant applying unit is solid lubricant blended with at least fatty acid metal salt and inorganic lubricant.

4. The lubricant supplying device according to claim 1, wherein fatty acid metal salt blended with the solid lubricant is zinc stearate.

5. The lubricant supplying device according claim 1, Wherein inorganic lubricant blended with the solid lubricant is boron nitride.

6. A process cartridge, comprising:
a photosensitive element; and
a photosensitive element lubricant applying unit, the process cartridge integrally supporting the photosensitive element and at least the photosensitive element lubricant applying unit, and being able to be attached to and detached from an apparatus main body, wherein
the photosensitive element lubricant applying unit is provided to each of a plurality of photosensitive elements and applies lubricant to a surface of each of the photosensitive element.

7. An image forming apparatus, comprising:
a plurality of photosensitive elements;
an intermediate transfer body that has a belt shape and to which toner images are transferred from the photosensitive elements; and
an intermediate transfer body lubricant applying unit that applies lubricant to a surface of an intermediate transfer body.

8. The image forming apparatus according to claim 7, further comprising:
a photosensitive element lubricant applying unit that is provided to each of the plurality of photosensitive elements and applies lubricant to a surface of each of the photosensitive elements.

9. The image forming apparatus according to claim 7, further comprising a process cartridge that includes:
a photosensitive element; and
a photosensitive element lubricant applying unit, the process cartridge integrally supporting the photosensitive element and at least the photosensitive element lubricant applying unit, and being able to be attached to and detached from an apparatus main body, wherein
the photosensitive element lubricant applying unit is provided to each of a plurality of photosensitive elements and applies lubricant to a surface of each of the photosensitive element.
